(19) United States
(12) Patent Application Publication
(10) Pub. No.: US 2009/0277663 A1
(43) Pub. Date: Nov. 12, 2009

(54) INSULATION OF CONDUCTORS WITH IMPROVED SEPARABILITY FROM PROCESSED BROKEN STONE

(76) Inventors: Pavel Valenta, Vsetin (CZ); Jaromir Fiala, Jablunka (CZ); Zlatko Srank, Praha (CZ); Libor Mastny, Praha (CZ); Pavel Mecir, Studenec (CZ)

Correspondence Address: NOTARO & MICHALOS P.C., 100 DUTCH HILL ROAD, SUITE 110, ORANGEBURG, NY, 10962-2100, US

(21) Appl. No.: 12/447,326

(22) PCT Filed: Oct. 26, 2007
(86) PCT No.: PCT/CZ07/00096

§ 371 Date: Jun. 25, 2009

(30) Foreign Application Priority Data
Oct. 27, 2006 (CZ) PV 2006-683

(51) Int. Cl. H01B 3/10; H01B 3/02; H01B 3/28; H01B 3/44; H01B 3/30

(52) U.S. Cl. 174/110 A; 174/110 R; 174/110 AR; 174/110 PM; 174/110 V; 174/110 SR; 174/110 FC

(57) ABSTRACT

The invention deals with insulation with improved separability from the processed broken stone designed as single-layer or multi-layer insulation surrounding an electric conductor where the principle is that at least one layer of the insulation is made of magnetic material and at the same time at least one layer is made of electrically non-conductive material. This magnetic material is beneficially produced as a mixture of the magnetic and non-magnetic main material component while it is especially advantageous if the content of the magnetic main material component in individual insulation layers is 5 to 60% of weight and the rest to 100% consists of the non-magnetic main material component, all related to the weight of individual layers, or even better, if the content of the magnetic main material component of individual insulation layers is 10 to 30% of weight, related to the weight of individual insulation layers. The magnetic main material component is beneficially produced on the basis of magnetite —Fe₃O₄, or on the basis of ferrite with the general formula Me^{II}Fe₂O₄, where Me represents Co, Mn, Ni, Ca, Cu, Zn, Mg, or ferrite with the general formula Ln^{II}Fe₂O₄, where Ln represents noble earth elements, or on the basis of noble earth elements in the oxidation degree II, or on the basis of ferric oxide in the modification γ-Fe₂O₃, or on the basis of powder iron, or on the basis of a magnetic alloy of iron or on the basis of a mixture or alloy containing the above mentioned magnetic partial components, where advantageous magnetic alloys of iron are alloys containing at least noble earth elements, or especially advantageous magnetic alloys of iron are alloys containing at least another noble earth element and B and/or Co while advantageous metallic noble earth elements are Nd and Sm. Or the magnetic main material component is made on the basis of magnetically hard materials of the AlNiCo or FeCoCr type. The non-magnetic main material component is beneficially produced on the basis of plastic material, advantageously selected from the group of polymers or copolymers, mainly from the group of elastomers as silicone or butadienstyrene rubber or plastic materials as PVC, PE, PP, or PTFE.

### FIELD OF THE INVENTION

The invention deals with insulation of conductors of electric current used mainly for industrial electric detonators. In particular, it deals with such a design of insulation enabling economically acceptable separation of remainders of this insulation or remainders of conductors with this insulation after the execution of blasting work from other substances or components from the processed broken stone.

### BACKGROUND OF THE INVENTION

Remainders of insulation of electric conductors, mainly of electric detonators used for blasting work in rock mining contaminate the resulting mined product, i.e. broken stone. In this case contamination is represented by the presence of insulation remainders in the mined material, which subsequently causes problems during the treatment of the material in technological equipment as e.g. crushers where the broken stone or mining product is ground or sorters where the product is sorted into the required fraction. The above mentioned contamination and entering of insulation remainders to the above mentioned processing machines result in frequent shutdowns of the machines caused by the necessity to remove the insulation remainders from them. In extreme cases the machines may even break down. This is why it is necessary to remove the concerned insulation remainders from the mined product, especially stone, which is carried out manually at present, or is not carried out at all since remainders of insulation are generally quite small. This fact increases the costs of the series of blasting work and treatment of mined stone, which is a considerable disadvantage in technological procedures comprising the use of otherwise very efficient and automated methods. As regards separation of electric conductors with insulation, incl. their remainders, from the other components of mechanical mixtures mechanical division procedures are frequently used. When being separated from loose materials these conductors and their remainders are commonly caught by sieves. A disadvantage of this method is that some remainders of concerned conductors and insulation can fall through the sieve. The above mentioned method is not suitable for catching remainders of electric conductors generated during the mining of stone and minerals with the use of electric detonators as this mining method leaves a considerable share of remainders of conductors in broken stone that can fall through the sieve. This is why electric conductors of magnetic material, e.g. tin-coated steel wire, are frequently used for the above mentioned purpose nowadays. After the execution of blasting work in this case you can use magnetic separation to separate remainders of electric conductors from non-magnetic substances of broken stone and other mechanical mixtures. The above mentioned mechanical separation method allows you to catch remainders of conductors with small dimensions. However, similarly to the first method it does not allow you to catch remainders of small remainders of the entire insulation. But the contents of small remainders of insulation material and the necessity of their removal may have a significant negative impact on laboriousness of this processing or the quality parameters of the processing product.

### SUMMARY OF THE INVENTION

The above mentioned disadvantages are reduced to the decisive extent and insulation with the possibility of easy machine separation, mainly from broken stone, is achieved with the use of insulation with improved separability from processed broken stone designed as single or multi-layer insulation surrounding an electric conductor in accordance with the presented invention where the principle is that at least one layer of the insulation is made of magnetic material and at the same time at least one layer is made of electrically non-conductive material. Here, we should point out that it may be advantageous if the insulation forms one or more layers made of a material that is magnetic and electrically non-conductive at the same time. This magnetic material can be beneficially produced as a mixture of the magnetic and non-magnetic main material component while it may be especially advantageous if the content of the magnetic main material component in individual insulation layers is 5 to 60% of weight and the rest to 100% consists of the non-magnetic main material component, all related to the weight of individual layers, or even better, if the content of the magnetic main material component of individual insulation layers is 10 to 30% of weight, related to the weight of individual insulation layers. The magnetic main material component may be beneficially produced on the basis of magnetite —Fe₃O₄, or on the basis of ferrite with the general formula Me^{II}Fe₂O₄, where Me represents Co, Mn, Ni, Ca, Cu, Zn, Mg, or ferrite with the general formula Ln^{II}Fe₂O₄, where Ln represents noble earth elements, or on the basis of noble earth elements in the oxidation degree II, or on the basis of ferric oxide in the modification γ-Fe₂O₃, or on the basis of powder iron, or on the basis of a magnetic alloy of iron or on the basis of a mixture or alloy containing the above mentioned magnetic partial components, where advantageous magnetic alloys of iron are alloys containing at least noble earth elements, or especially advantageous magnetic alloys of iron are alloys containing at least one noble earth element and B and/or Co while advantageous metallic noble earth elements are Nd and Sm.

Or alternatively the magnetic main material component is made on the basis of magnetically hard materials of the AlNiCo or FeCoCr type. The non-magnetic main material component is beneficially produced on the basis of plastic material, advantageously in such a way that the plastic material is selected from the group of polymers or copolymers while it is especially beneficial if the polymer or copolymer is a substance from the group of elastomers or plastic materials, where elastomers are beneficially selected in the form of silicone or butadienstyrene rubber or plastic materials are beneficially selected in the form of PVC, PE, PP, or PTFE.

This way insulation is created where magnetic substances contained in at least one of its layers enable magnetic separation of remainders of this insulation or insulation with a non-magnetic conductor from broken stones, which eliminates the hitherto considerable disadvantage of the necessity of manual separation of these remainders or in comparison with not performed separation reduces the risk of clogging or damaging processing equipment of broken stone contaminated by remainders of detonator conductors with insulation. This way you can further achieve extraction of non-ferrous non-magnetic metals with magnetic separation if they are used as conductors in insulation based on the presented solution.

### DESCRIPTION OF THE PREFERRED EMBODIMENTS

### Example 1

Insulation material on the basis of PVC was prepared containing 54 weight parts of PVC, 22 weight parts of a softening agent, 2 parts of a heat stabilizer, 2 parts of lubricant and 20 weight parts of magnetite —FeFe₂O₄. This material was used as insulation of a conductor of tin-coated steel wire. The evaluation of utility parameters showed that the insulation complied with the required resistance against rubbing, against cold, electric insulation strength and electric capacity.

### Example 2

Insulation material on the basis of PE was prepared containing 90 weight parts of PE and 10 weight part of ferric oxide in the form γ-Fe₂O₃. This material was used as insulation of a conductor of tin-coated steel wire. The evaluation of utility parameters showed that the insulation complied with the required resistance against rubbing, against cold, electric insulation strength and electric capacity.

### Example 3

Insulation material on the basis of silicone rubber was prepared containing 69 weight parts of silicone rubber, 5 parts of a softening agent, 1 part of a vulcanizing agent and 25 weight parts of ferrite —CaFe₂O₄. This material was used as insulation of a conductor of tin-coated steel wire.

The evaluation of utility parameters showed that the insulation complied with the required resistance against rubbing, against cold, electric insulation strength and electric capacity.

### Example 4

The above mentioned electric conductors prepared in accordance with examples 1 to 3 were used for blasting work during minim of sodium chloride for food purposes. It was established that the separation efficiency of insulation remainders of the electric conductor was 100% in the case of materials based on the examples 1 and 3 and 70% in the case of the material based on the example 2.

### INDUSTRIAL APPLICABILITY

The equipment based on the presented invention can be used for blasting work where the resulting broken material is subsequently processed and the remainders of insulation or insulation with conductors must be separated from the broken material.

1. Insulated conductor, produced from non-magnetic material and intended for being used for supplying of electric current to industrial electric detonators for blasting work, where later crushing and/or sorting of mined material is supposed, insulated conductor being created as an electrically insulated conductor with at least one insulating layer, characterized in that at least one insulating layer is made of magnetic material.

2. Insulated conductor according to claim 1, characterized in that the magnetic material is created as a mixture of the magnetic material component and non-magnetic material component, wherein the content of the magnetic material component in individual insulating layers is 10 to 30% of weight, related to the weight of individual insulating layers.

3. Insulated conductor according to claim 2, characterized in that the magnetic material component is produced on the basis of magnetite —Fe₃O₄, or on the basis of ferrite with the general formula Me^{II}Fe₂O₄, where Me represents Co, Mn, Ni, Ca, Cu, Zn, Mg, or ferrite with the general formula Ln^{II}Fe₂O₄, where Ln represents rare earth elements, or on the basis of rare earth elements in the oxidation degree II, or on the basis of ferric oxide in the modification γ-Fe₂O₃, or on the basis of powder iron, or on the basis of a magnetic alloy of iron, or on the basis of a mixture or alloy containing the above mentioned magnetic partial components.

4. Insulated conductor according to claim 3, characterized in that the magnetic alloys of iron are alloys containing also at least rare earth elements.

5. Insulated conductor according to claim 4, characterized in that the magnetic alloys of iron are alloys containing at least another metallic rare earth element and B and/or Co.

6. Insulated conductor according to claim 5, characterized in that the metallic rare earth elements are Nd and Sm.

7. Insulated conductor according to claim 2, characterized in that the magnetic material component is produced on the basis of magnetically hard material of the AlNiCo or FeCoCr type.

8. Insulated conductor according to claim 1, characterized in that the non-magnetic material component is made on the basis of elastomer silicone rubber or butadienstyrene rubber or PVC or PE or PP or PTFE.

9. Insulated conductor according to claim 2, characterized in that the non-magnetic material component is made on the basis of elastomer silicone rubber or butadienstyrene rubber or PVC or PE or PP or PTFE.

10. Insulated conductor according to claim 3, characterized in that the non-magnetic material component is made on the basis of elastomer silicone rubber or butadienstyrene rubber or PVC or PE or PP or PTFE.

11. Insulated conductor according to claim 4, characterized in that the non-magnetic material component is made on the basis of elastomer silicone rubber or butadienstyrene rubber or PVC or PE or PP or PTFE.

12. Insulated conductor according to claim 5, characterized in that the non-magnetic material component is made on the basis of elastomer silicone rubber or butadienstyrene rubber or PVC or PE or PP or PTFE.

13. Insulated conductor according to claim 6, characterized in that the non-magnetic material component is made on the basis of elastomer silicone rubber or butadienstyrene rubber or PVC or PE or PP or PTFE.

14. Insulated conductor according to claim 7, characterized in that the non-magnetic material component is made on the basis of elastomer silicone rubber or butadienstyrene rubber or PVC or PE or PP or PTFE.
